(19) United States
(12) Patent Application Publication
(10) Pub. No.: US 2015/0284108 A1
(43) Pub. Date: Oct. 8, 2015

(54) NOSE WHEEL TIRE PRESSURE SENSING SYSTEM AND APPARATUS

(71) Applicant: GOODRICH CORPORATION, Charlotte, NC (US)

(72) Inventors: STEVEN KELLER, Union, OH (US); PAUL L. SUMMERS, Troy, OH (US)

(73) Assignee: GOODRICH CORPORATION, Charlotte, NC (US)

(21) Appl. No.: 14/247,060

(22) Filed: Apr. 7, 2014

(51) Int. Cl. B64D 43/00; B64C 25/36

(52) U.S. Cl. CPC B64D 43/00; B64C 25/36

(57) ABSTRACT

Landing gear tire pressure sensing systems, methods and apparatuses are provided. In various embodiments, a tire pressure sensing system may be mounting to a landing gear. The system may comprise a rotating portion and a stationary portion. The rotating portion and stationary portion may be in electronic communication. The stationary portion may be configured to communicate an indication of tire pressure to a control unit.

### FIELD

The present disclosure relates to tire pressure sensing, and more specifically, to a tire pressure sensing system, apparatus and method for a nose gear/wheel mounted sensor.

### BACKGROUND

Aircraft are often towed by the nose landing gear. For example, the tow bar of a tug may be coupled to the nose landing gear, allowing the tug to move and/or position the aircraft on the tarmac. More specifically, pins from the tow bar may be inserted into the axle of the nose landing gear to connect the tow bar to the aircraft. In order to make this connection, the region around the axle may need to be relatively free of interfering structure to allow the aircraft to be towed.

### SUMMARY

In various embodiments, a tire pressure monitoring system may comprise a rotating module and a stationary module. The rotating module may include a body and a pressure sensor. The body may be configured to be installed in a wheel. The pressure sensor may be housed within the body. The pressure sensor may be in fluid communication with a chamber defined by a tire installed on the wheel. The stationary module may be configured to be mounted on a landing gear strut. The stationary module may be configured to receive data from the rotating module.

In various embodiments, a landing gear may comprise a strut, an axle, a wheel and a tire. The strut may include a stationary sensor portion. The axle may be operatively coupled to the strut. The wheel may be rotatably mounted on the axle. The wheel may include a rotating sensor portion. The rotating sensor portion may be in electronic communication with the stationary sensor portion. The tire may be mounted on the wheel. The tire may define a chamber that is configured to be pressurized. The rotating sensor portion may be in fluid communication with the chamber.

The forgoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures, wherein like numerals denote like elements.

FIG. 1 illustrates a front view of an aircraft with deployed landing gear, in accordance with various embodiments.

FIG. 2A illustrates a front view of a nose landing gear, in accordance with various embodiments.

FIG. 2B illustrates a cross-sectional front view of a landing gear and wheel assembly, in accordance with various embodiments.

FIG. 3 illustrates a perspective view of a rotating module, in accordance with various embodiments.

FIG. 4 is a block diagram of a tire pressure monitoring system, in accordance with various embodiments.

### DETAILED DESCRIPTION

The detailed description of exemplary embodiments herein makes reference to the accompanying drawings, which show exemplary embodiments by way of illustration. While these exemplary embodiments are described in sufficient detail to enable those skilled in the art to practice the inventions, it should be understood that other embodiments may be realized and that logical changes and adaptations in design and construction may be made in accordance with this invention and the teachings herein. Thus, the detailed description herein is presented for purposes of illustration only and not of limitation. The scope of the invention is defined by the appended claims. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact.

Furthermore, any reference to singular includes plural embodiments, and any reference to more than one component or step may include a singular embodiment or step. Surface shading lines may be used throughout the figures to denote different parts but not necessarily to denote the same or different materials.

As used herein, “aft” refers to the direction associated with the tail (e.g., the back end) of an aircraft, or generally, to the direction of exhaust of the gas turbine. As used herein, “forward” refers to the direction associated with the nose (e.g., the front end) of an aircraft, or generally, to the direction of flight or motion.

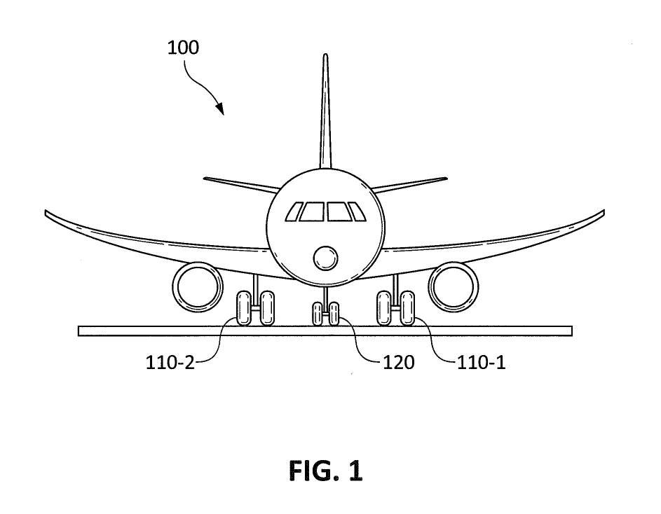

In various embodiments and with reference to FIG. 1, an aircraft 100 may comprise a landing gear system including a first main landing gear 110-1, a second main landing gear 110-2, and a nose landing gear 120. Nose landing gear 120 may be installed in a forward portion of the aircraft fuselage (e.g., forward of the engines) at the nose of the fuselage. First main landing gear 110-1 and second main landing gear 110-2 may be installed aft nose landing gear 120. First main landing gear 110-1, second main landing gear 110-2, and nose landing gear 120 may generally support the aircraft when it is not flying allowing it to take off, land, and taxi without damage.

In various embodiments, aircraft are often towed by the nose axle of nose landing gear 120. As such, aircraft monitoring systems including, for example, sensors need to be installed on the nose gear in such a manner that the aircraft 100 is able to be towed and the monitoring systems can adequately monitor the aircraft 100.

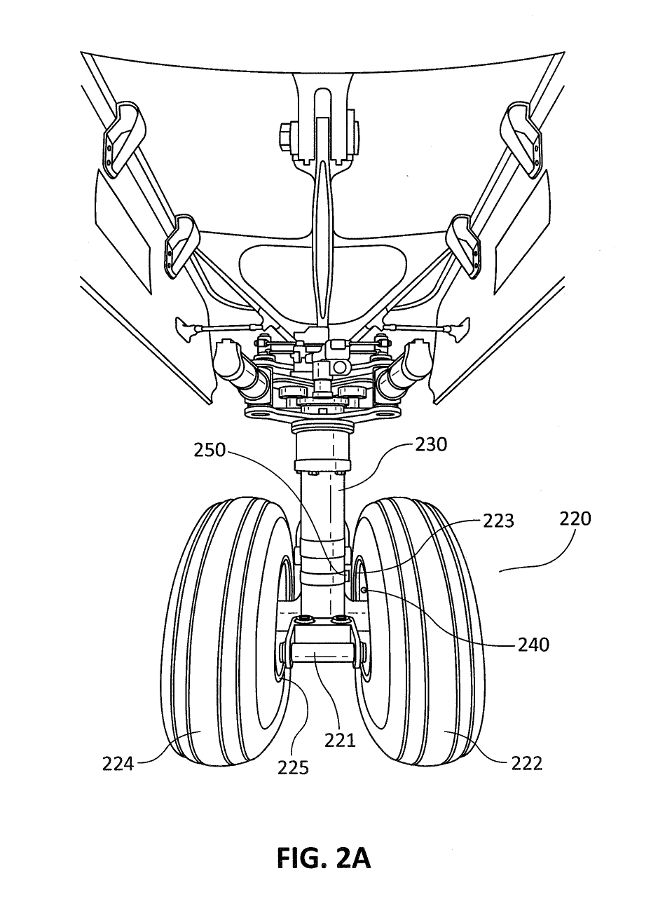

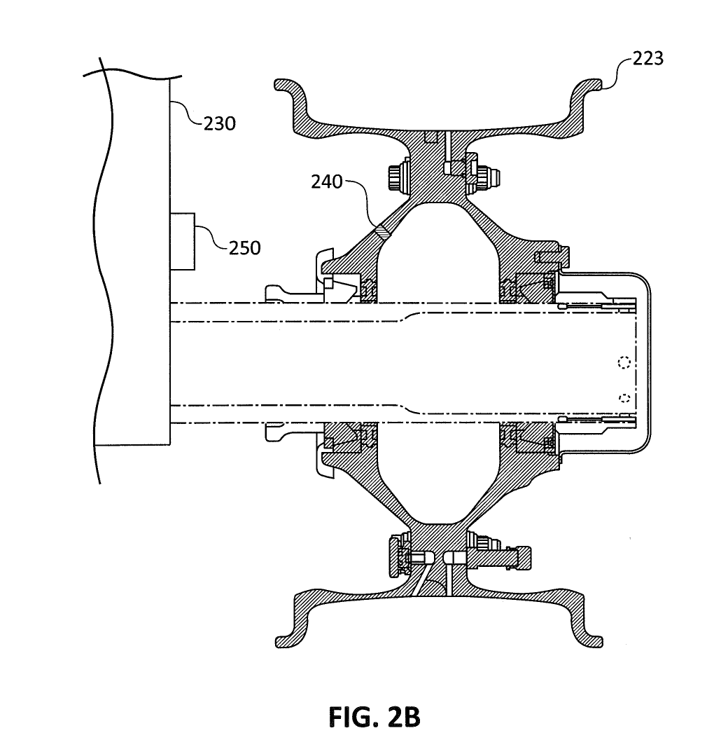

In various embodiments and with reference to FIG. 2A, nose landing gear 220 may comprise a first wheel 223 and a second wheel 225 coupled to landing gear strut 230. First wheel 223 may be operatively coupled to a tire 222. In this regard, tire 222 may be mounted on first wheel 223. Tire 222 may define a pressurizable chamber between tire 222 and first wheel 223. Similarly, a tire 224 may be mounted on and/or coupled to second wheel 225. First wheel 223 and second wheel 225 may operatively couple to and/or rotatably couple to an axle assembly 221. Axle assembly 221 may operatively couple to landing gear strut 230.

In various embodiments, it may be desirable to monitor tire pressure for tire 222 and/or tire 224 (e.g., the pressure inside the chamber defined between tire 222 and first wheel 223 and/or tire 224 and second wheel 225). In this regard, a tire pressure sensor system may be installed on first wheel 223 and/or second wheel 225. The tire pressure sensor system may comprise a rotating module 240 (e.g., a rotating coil, a rotating sensor, a rotation portion and/or the like) and a stationary module 250 (e.g., a stationary coil, a stationary sensor, a stationary portion and/or the like).

In various embodiments and with reference to FIGS. 2A and 2B, rotating module 240 may be installed on an inboard portion of first wheel 223. In this regard, rotating module 240 may be installed on a portion of first wheel 223 adjacent landing gear strut 230. Stationary module 250 may be installed on a portion of landing gear strut 230. For example, the stationary module 250 may be installed on an outboard portion of landing gear strut 230 that is inboard of first wheel 223 and/or tire 222. In this regard, the stationary module 250 and rotating module 240 of the tire pressure sensor system may be installed in the area between landing gear strut 230 and wheel 223/tire 222. Moreover, this installation arrangement may allow for towing of the aircraft by a tug at nose landing gear 220 where a tug is configured to connect to nose gear 220 with pins through outboard portions of first wheel 223 and/or second wheel 225.

In various embodiments and in operation, stationary module 250 may be in relatively close proximity to rotating module 240. By minimizing the distance between stationary module 250 and rotating module 240, the tire pressure sensor system may require less power to operate and/or transfer data. Moreover, as the distance between stationary module 250 and rotating module 240 increases, the system may require more power and the probability of increased noise and/or interference is greater.

In various embodiments, the tire pressure sensor system may be configured to monitor tire pressure (e.g., the pressure in the chamber defined by tire 222 and/or the pressure in the chamber defined by tire 224). The tire pressure sensor system may also be configured to monitor the temperature of the tire, wheel and/or surrounding environment.

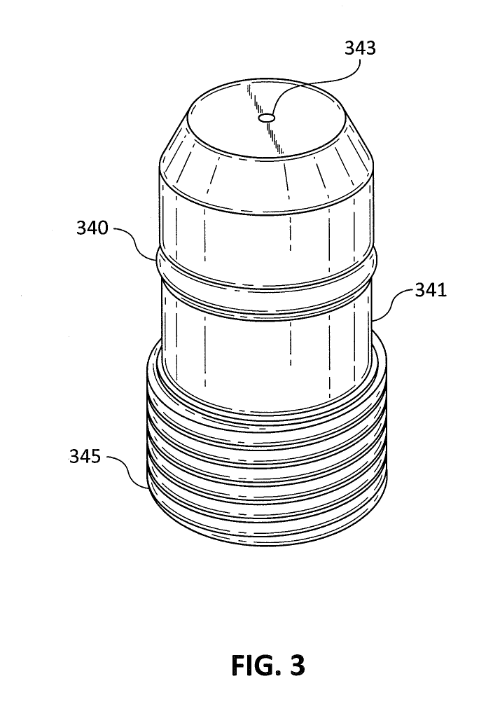

In various embodiments and with reference to FIG. 3, rotating module 340 may include a body 341. Body 341 may include a pressure sensing port 343. Body 341 may also include and/or define a thread 345. In this regard, rotating module 340 may be rotatably installed in a port in the wheel. Such a port in a wheel may offer access to the volume between the wheel and a tire, which in operation, is typically pressurized. In this regard, pressure sensing port 343 of rotating module 340 may be in fluid communication with the pressurized air within the tire.

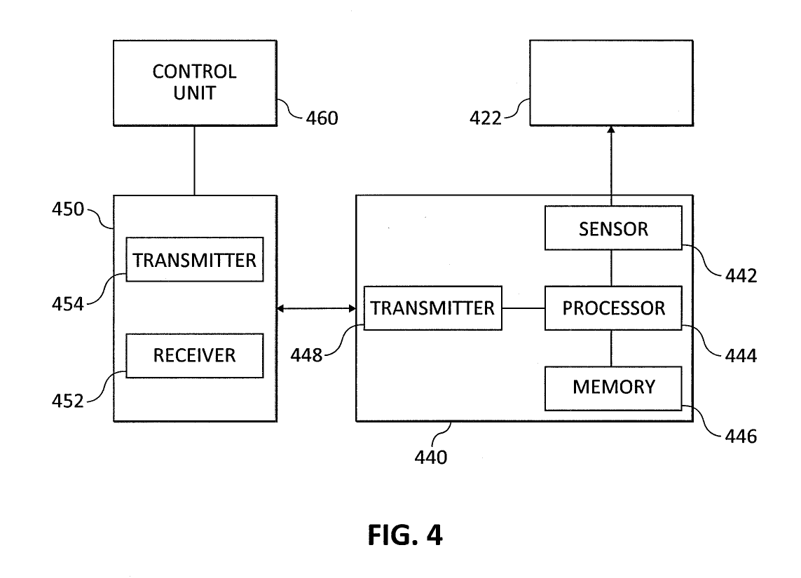

In various embodiments and with reference to FIG. 4, rotating module 440 may comprise a pressure sensor 442, a processor 444, and a memory 446. Pressure sensor 442 may be in fluid communication with a tire 422 and/or the pressurizable chamber defined by tire 422. Rotating module 440 may also comprise a transmitter 448. Rotating module 440 may comprise and/or be operatively coupled to a suitable power source. For example, rotating module 440 may comprise a battery. Rotating module 440 may also be coupled to an aircraft power source. In this regard, rotating module 440 may be coupled to a hard wired power source that is configured to provide power to a brake actuator and/or other suitable system that is located within the vicinity of the wheel. Rotating module 440 may be configured to receive power via an inductive power source.

In various embodiments, rotating module 440 and/or stationary module 450 may be capable of being read during an on-ground inspection (e.g., a pilot walk around). In this regard, rotating module 440 and/or stationary module 450 may be read with a “wand device” (e.g., a detector, a smart phone, and/or the like). Rotating module 440 and/or stationary module 450 may also comprise a suitable indicator (e.g., a visual indicator, an audio indicator, and/or the like).

In various embodiments, stationary module 450 may comprise a receiver 452 and a transmitter 454. In various embodiments, stationary module 450 may be operatively coupled and/or in electronic communication with a control unit 460. Transmitter 448 of rotating module 440 may be in electronic communication with and configured to transmit data indicative of a pressure condition in tire 422 measured by pressure sensor 442 to receiver 452 of stationary module 450. Transmitter 454 of stationary module 450 may be configured to communicate the data to control unit 460.

In various embodiments, control unit 460 may be any suitable control unit configured to monitor, analyze, transmit, store, and/or otherwise process data. Control unit 460 may comprise a processor and a memory. Control unit 460 may also comprise one or more transmitters and/or receivers configured to transmit and receive data to and from various aircraft systems. Control unit 460 may be, for example, the aircraft brake control unit, and/or the like.

In various embodiments, stationary module 450 may be coupled to any suitable power source and/or aircraft system. For example, stationary module 450 may be coupled to an aircraft power source (e.g., a hard wired power source). Stationary module 450 may also include a battery.

In various embodiments and with continued reference to FIG. 4, rotating module 440 may be in electronic communication with stationary module 450. In this regard, data may be transferred from rotating module 440 to stationary module 450. This data may be further communicated from stationary module 450 to a control unit 460, the cockpit, and/or the like. Control unit 460 may be configured to analyze the data provided by rotating module 440 and/or stationary module 450. For example, control unit 460 may be configured to determine a sensed pressure and/or a pressure condition based on the data. Control unit 460 may also be configured to compare the data to a threshold be determine whether the pressure in the tire is outside a predetermined pressure range.

In various embodiments, control unit 460 may be capable of providing an indication of a tire pressure condition. For example, control unit 460 may illuminate a cockpit light in response to a tire pressure condition being below a threshold. Moreover, control unit 460 may be capable of transmitting and/or displaying a sensed pressure in the cockpit.

In various embodiments, and in operation, tire pressure is generally checked as part of a preflight check by the pilot. This preflight check may include, for example, a visual inspection and an evaluation of tire pressure based on a tire pressure reading from the tire pressure sensor system and/or control unit 460. The tire pressure sensor system and/or control unit 460 may be capable of alerting a crew member to a low tire pressure condition in response to a flight event (e.g., a taxi, takeoff, and/or landing). For example, the tire pressure sensor system and/or control unit 460 may also be capable of measuring tire pressure and/or indicating low tire pressure in flight and/or prior to a landing event. In this regard, the tire pressure sensor system and more specifically rotating module 440 and stationary module 450 may monitor tire pressure in a tire in a stowed position to determine whether a tire has low pressure prior to landing.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the inventions. The scope of the inventions is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods and apparatus are provided herein. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A tire pressure monitoring system, comprising:
a rotating module comprising,
a body configured to be installed in a wheel,
a pressure sensor housed within the body, the pressure sensor in fluid communication with a chamber defined by a tire installed on the wheel; and
a stationary module configured to be mounted on a landing gear of an aircraft comprising a landing gear strut, the stationary module configured to receive data from the rotating module,. wherein the rotating module is configured to be mounted adjacent the landing gear strut, wherein the rotating module is configured to be mounted adjacent the landing gear strut.

2. The tire pressure monitoring system of claim 1, wherein the body comprises a threaded portion and is configured to be installed within a port in the wheel.

3. The tire pressure monitoring system of claim 1, wherein the stationary portion is in electronic communication with a control unit.

4. The tire pressure monitoring system of claim 3, wherein the control unit is configured to provide an indication of tire pressure.

5. The tire pressure monitoring system of claim 4, wherein the indication of tire pressure is at least one of a low pressure indication and a pressure reading.

6. The tire pressure monitoring system of claim 1, wherein the rotating portion further comprises a processor and a memory.

7. The tire pressure monitoring system of claim 1, wherein the body is installed on an in-board potion of the wheel.

8. The tire pressure monitoring system of claim 1, wherein the tire pressure monitoring system is installed on a nose landing gear.

9. The tire pressure monitoring system of claim 8, wherein the nose landing gear is capable of being towed by a tug.

10. A landing gear, comprising:
a strut comprising a stationary sensor portion mounted to the strut;
an axle operatively coupled to the strut;
a wheel rotatably mounted on the axle and comprising a rotating sensor portion installed in the wheel in electronic communication with the stationary sensor portion; and
a tire mounted on the wheel and defining a chamber that is configured to be pressurized, wherein the rotating sensor portion is in fluid communication with the chamber.
wherein the landing gear is an aircraft landing gear, and
wherein the mounting position of the stationary sensor portion is adjacent to the installation position of the rotating sensor portion.

11. The landing gear of claim 10, wherein the stationary sensor portion is in electronic communication with a control unit.

12. The landing gear of claim 11, wherein the control unit is configured to provide an indication of pressure in the chamber.

13. The landing gear of claim 12, wherein the indication is at least one of a pressure reading and an indicia that the pressure in the chamber is below a threshold.

14. The landing gear of claim 10, wherein the rotating sensor portion comprises a threaded body that is rotatably receivable within a port in the wheel.

15. The landing gear of claim 10, wherein the rotating sensor portion is installed on the in-board side of the wheel, adjacent the strut.

16. The tire pressure monitoring system of claim 1, wherein the wheel is coupled to an axle assembly of the landing gear,
wherein the axle assembly is coupled to the landing gear strut, and
wherein the installation and mounting arrangement of the body and the stationary module allows for towing of the aircraft by the axle.

17. The tire pressure monitoring system of claim 1, wherein the rotating module is configured to be mounted in relatively close proximity to the stationary module.

18. The tire pressure monitoring system of claim 1, wherein the wheel is coupled to the landing gear strut and wherein the rotating module and stationary module are configured to locate in an area between landing gear strut and the wheel.

19. The tire pressure monitoring system of claim 10, wherein the rotating sensor portion and the stationary sensor portion are configured to locate in an area between landing gear strut and the wheel.
